(19) United States
(12) Patent Application Publication
(10) Pub. No.: US 2005/0124759 A1
(43) Pub. Date: Jun. 9, 2005

(54) Aqueous coating compositions method for the production thereof and their use for producing in particular thixotropic coating compositions

(76) Inventors: Carsten Heldmann, Mainz (DE); Thomas Wirth, Staechen (DE)

Correspondence Address: CONNOLLY BOVE LODGE & HUTZ, LLP, P O BOX 2207, WILMINGTON, DE, 19899, US

(21) Appl. No.: 10/504,254

(22) PCT Filed: Feb. 14, 2003
(86) PCT No.: PCT/EP03/01487

(30) Foreign Application Priority Data
Feb. 23, 2002 (DE) 102-07-925.0

(51) Int. Cl. C08K 3/00

(52) U.S. Cl. 524/845

(57) ABSTRACT

The invention relates to aqueous coating agents containing binding agents and at least one aqueous plastic dispersion, based on one homopolymer and/or copolymer that is/are derived from α,β unsaturated compounds (M). Said coating agents also contain at least one protective colloid containing hydroxyl groups and comprising ethylenically unsaturated groups and optionally additional feed material that is conventionally used for producing coating agents. According to the invention, the protective colloid contains ethylenically unsaturated groups in a quantity that is expressed as the molar degree of substitution MS of unsaturated groups, R_{unsaturated}, ranging between 0.001 and 1.0. The invention also relates to a method for producing said coating agents and to their use for producing thixotropic coating agents by the addition of thixotroping agents, in particular metal chelates.

Aqueous polymer dispersions have long been used on account in particular of their eco-friendly character for preparing aqueous coating compositions with binder which are suitable on the one hand as paints for decorating and protecting substrates and on the other hand as adhesives for joining substrates.

In the context of the use of paints it is very advantageous if the paints are on the one hand of such high viscosity that they do not drip but on the other hand can be induced to have a flow behavior for which unevennesses, such as brush lines or brush furrows originating from brush application, for example, have the opportunity to even out. Conditions are optimum when a paint which is pseudoplastic per se responds to the attack of a shearing force by opposing the attacking force with a resistance which grows as the shearing force increases and which when a certain shearing force—which ought not to be either too high or too low—is reached suddenly collapses, with the paint then displaying flow behavior which is typical for thixotropic paints, i.e., time-dependent reduction in viscosity when the shear rate changes. Paints exhibiting such rheology do not drip from the applicator (e.g., brush or lamb's wool roller) but under the shearing forces which normally arise in the course of processing become of such low viscosity that unevennesses, e.g., brush lines or brush furrows, are able largely to flow out. Left at rest, the paint then regains a relatively high viscosity with sufficient rapidity that it is impossible for “curtaining” to develop when the paint is applied to vertical surfaces. Moreover, a paint having such rheology allows paint application in a single operation in a substantially greater film thickness than is possible in the case of paints having a more simple flow behavior. In addition it is possible for the user to work more quickly or economically, since when new paint is taken on each time the processing equipment is able to hold a larger quantity of paint, owing to the absence of the tendency to drip, than with paints having conventional flow properties.

In the case of aqueous formulations with binder which are used as adhesives as well it is possible for the thixotroping described to be of advantage. For example, thixotroped dispersions which function as adhesives are often much less prone toward sedimentation than nonthixotroped dispersions. In spite of this, thixotroped dispersions, in a manner similar to that for nonthixotroped dispersions, can be pumped or processed on high-speed machines, since the original, low viscosity of the dispersion can easily be reestablished by shearing.

Within the field of alkyd resin paints there have long been thixotropic paints which possess the aforementioned advantages, as a result of the addition of polyamide resin, for example.

Thixotropic paints based on aqueous polymer dispersions are also known. In the case of such materials the thixotropy can be produced in the paint by the incorporation of specific additives, such as montmorrilonites or water glass, into the paint by mixing, for example.

DE-A-12 42 306 discloses a thixotropic coating material based on a film-forming polymer, an organic polyhydroxy compound, and a titanium chelate in aqueous medium, for which the film-forming polymer used is a water-emulsified homopolymer or copolymer of vinyl esters, acrylic and methacrylic esters, styrene, acrylonitrile, and butadiene, the polyhydroxy compound used is a natural or synthetic, water-soluble, hydroxyl-containing organic colloid, and from 0.2 to 5% by weight of titanium chelate is used, based on the emulsion weight.

DE-A-26 20 189 describes thixotropic mixtures composed of a) one or more aqueous polymer dispersions comprising a copolymer of α,β-unsaturated compounds which contains acetoacetate groups, b) a hydroxyl-containing protective colloid, c) a heavy metal chelate, and d) other usual additives.

Although these processes are superior to others described before them, they still have certain disadvantages. For example, when some titanium chelates are used, it is common for yellowing phenomena to appear in the coating, the propensity to yellow increasing with the amount of chelate. Additionally, many of the chelates are of very limited solubility in water and, in particular at the point of dropwise introduction, they cause a low level of formation of coagulum, which in the case of gloss paints, for example, can have adverse effects on the gloss. The combination of a chelate with dispersions which comprise hydroxyl-containing protective colloids frequently also leads to thixotropic coating compositions having an unsatisfactory gel structure (gel strength). In order to achieve a sufficient gel strength it is possible to resort to increasing either the amount of chelate or the amount of hydroxyl-containing protective colloid in the dispersion, or both, but in that case it may be necessary to accept, with an increasing amount of chelate, a greater prevalence of disadvantages (yellowing propensity, formation of coagulum at the point of dropwise introduction) or, with an increasing amount of protective colloid, it may be necessary to accept greater prevalence of disadvantages (poor leveling properties on account of increased viscosity, reduced water sensitivity of the polymer film as a result of the higher fraction of hydroxyl-containing protective colloid).

DE-A-197 08 531 and DE-A-197 51 712 describe the use of water-soluble, nonionic cellulose ethers from the group of the alkylcelluloses and hydroxyalkylcelluloses which are additionally substituted by butenyl and 2-propenyl groups as protective colloids for emulsion polymerization. The examples specify the preparation of polymer dispersions with these hydroxyl-containing protective colloids. Aqueous coating compositions, such as paints and/or adhesives, with binder that comprise these polymer dispersions, however, are not disclosed.

It was an object of the present invention, therefore, to provide aqueous coating compositions with binder which can be used either as adhesives or as paints and which exhibit the disadvantages described above either not at all or only to a small extent.

Another object of the present invention was to provide aqueous coating compositions with binder which following the addition of equal or smaller amounts of metal chelates, in contrast to the known coating compositions, are distinguished by a markedly improved thixotropability (gel strength); it is intended that the preparation of the binder used should take place using equal or smaller amounts of hydroxyl-containing protective colloid.

Surprisingly it has now been found that these objects are achieved by preparing the binders used for the coating compositions of the invention using hydroxyl-containing protective colloids which contain ethylenically unsaturated radicals.

The present invention accordingly provides aqueous coating compositions with binder, comprising
at least one aqueous polymer dispersion based on a homopolymer and/or copolymer derived from α,β-unsaturated compounds (M) which
comprises at least one hydroxyl-containing protective colloid having ethylenically unsaturated radicals, and
if desired, further ingredients customary for the preparation of coating materials.

The selection of the α,β-unsaturated compounds (M) suitable for preparing the polymer dispersions is not critical per se. Suitability extends to all monomers usually used for preparing polymer dispersions that can be combined with one another rationally in accordance with the requirements of the art.

Preference as principal monomers (MP) is given to vinyl esters of carboxylic acids having 1 to 18 carbon atoms (MP1), esters and, respectively, monoesters of ethylenically unsaturated C₃-C₈ monocarboxylic and dicarboxylic acids with C₁-C₁₈ alkanols (MP2), aromatic or aliphatic α,β-unsaturated, optionally halogen-substituted hydrocarbons (MP3). As functional monomers (MF) it is possible to use not only ionic monomers (MF1) but also nonionic monomers (MF2), and also further ethylenically unsaturated monomers (MF3).

As vinyl esters of carboxylic acids having 1 to 18 carbon atoms (MP1) it is possible to use any of the monomers known to the skilled worker. Particular preference, however, is given to vinyl esters of carboxylic acids having 1 to 4 carbon atoms, such as vinyl formate, vinyl acetate, vinyl propionate, vinyl isobutyrate, vinyl pivalate, and vinyl 2-ethylhexanoate, for example; vinyl esters of saturated, branched monocarboxylic acids having 9, 10 or 11 carbon atoms in the acid radical (®Versatic acids); vinyl esters of relatively long-chain saturated and unsaturated fatty acids, examples being vinyl esters of fatty acids having 8 to 18 carbon atoms, such as vinyl laurate and vinyl stearate, for example; and vinyl esters of benzoic acid or of p-tert-butylbenzoic acid and also mixtures thereof, such as mixtures of vinyl acetate and a Versatic acid or of vinyl acetate and vinyl laurate, for example. Particular preference is given to vinyl acetate.

As esters and, respectively, monoesters of ethylenically unsaturated C₃-C₈ mono- and dicarboxylic acids with C₁-C₁₈ alkanols (MP2) it is possible to use any of the monomers known to the skilled worker. The esters and, respectively, monoesters of ethylenically unsaturated C₃-C₈ monocarboxylic and dicarboxylic acids with C₁-C₁₂ alkanols are preferred, with C₁-C₈ alkanols or C₅-C₈ cycloalkanols being particularly preferred.

Suitable C₁-C₁₈ alkanols are for example methanol, ethanol, n-propanol, isopropanol, 1-butanol, 2-butanol, isobutanol, tert-butanol, n-hexanol, 2-ethylhexanol, lauryl alcohol, and stearyl alcohol. Suitable cycloalkanols are for example cyclopentanol and cyclohexanol. Particularly preferred are the esters of acrylic acid, of (meth)acrylic acid, of crotonic acid, of maleic acid, of itaconic acid, of citraconic acid, and of fumaric acid. Especially preferred are the esters of acrylic acid and/or of (meth)acrylic acid, such as, for example, methyl(meth)acrylate, ethyl(meth)acrylate, isopropyl (meth)acrylate, n-butyl(meth)acrylate, isobutyl(meth)acrylate, 1-hexyl (meth)acrylate, tert-butyl(meth)acrylate, 2-ethylhexyl(meth)acrylate, and also the esters of fumaric acid and of maleic acid, such as, for example, dimethyl fumarate, dimethyl maelate, di-n-butyl maleate, di-n-octyl maleate, and di-2-ethylhexyl maleate. If desired it is also possible for said esters to be substituted by epoxy and/or hydroxyl groups.

Examples of aromatic or aliphatic α,β-unsaturated, optionally halogen-substituted hydrocarbons (MP3) are ethene, propene, 1-butene, 2-butene, isobutene, styrene, vinyltoluene, vinyl chloride, and vinylidene chloride, with ethene and styrene being preferred.

By ethylenically unsaturated ionic monomers (MF1) are meant in the present specification preferably those ethylenically unsaturated monomers which have a water solubility of more than 50 g/l, preferably more than 80 g/l, at 25° C. and 1 bar and which in dilute aqueous solution at a pH of 2 and/or 11 are more than 50%, preferably more than 80% in ionic compound form or else at a pH of 2 and/or 11 are more than 50%, preferably more than 80%, transformed into an ionic compound by protonation or deprotonation.

Suitable ethylenically unsaturated ionic monomers (MF1) are those compounds which carry at least one carboxylic acid, sulfonic acid, phosphoric acid or phosphonic acid group directly adjacent to the double bond unit or else are joined to it via a spacer. Examples that may be mentioned include the following: α,β-unsaturated C₃-C₈ monocarboxylic acids, α,β-unsaturated C₅-C₈ dicarboxylic acids and their anhydrides, and monoesters of α,β-unsaturated C₄-C₈ dicarboxylic acids.

Preference is given to unsaturated monocarboxylic acids, such as acrylic acid and (meth)acrylic acid and their anhydrides, for example; unsaturated dicarboxylic acids, such as maleic acid, fumaric acid, itaconic acid, and citraconic acid and their monoesters with C₁-C₁₂ alkanols, such as monomethyl maleate and mono-n-butyl maleate, for example. Further preferred ethylenically unsaturated ionic monomers MF1 are ethylenically unsaturated sulfonic acids such as vinylsulfonic acid, 2-acrylamido-2-methylpropanesulfonic acid, 2-acryloyloxyethanesulfonic acid, and 2-meth-acryloyloxyethanesulfonic acid, 3-acryloyloxy- and 3-methacryloyl-oxypropanesulfonic acid, vinylbenzenesulfonic acid, and also ethylenically unsaturated phosphonic acids, such as vinylphosphonic acid.

In addition, as well as the stated acids, it is also possible to use their salts, preferably their alkali metal or ammonium salts, and with particular preference their sodium salts, such as the sodium salts of vinylsulfonic acid and of 2-acrylamidopropanesulfonic acid, for example.

The ethylenically unsaturated free acids referred to, in aqueous solution at a pH of 11, are predominantly in the form of their conjugate bases in anionic form and, like the stated salts, can be referred to as anionic monomers.

Also suitable as ethylenically unsaturated ionic monomers (MF1) are monomers having cationic functionality, such as monomers deriving from quaternary ammonium groups, for example. Preference, however, is given to anionic monomers.

By ethylenically unsaturated nonionic monomers (MF2) are meant in the present specification preferably those ethylenically unsaturated compounds which have a water solubility of more than 50 g/l, preferably more than 80 g/l, at 25° C. and 1 bar and which in dilute aqueous solution at a pH of 2 and at a pH of 11 are predominantly in nonionic form.

Preferred ethylenically unsaturated nonionic monomers (MF2) are not only the amides of the carboxylic acids specified in connection with the ethylenically unsaturated ionic monomers (M3), such as (meth)acrylamide and acrylamide, for example, but also water-soluble N-vinyl lactams, such as N-vinylpyrrolidone, for example, and compounds which as ethylenically unsaturated compounds contain covalently bonded polyethylene glycol units, such as polyethylene glycol monoallyl or diallyl ethers or the esters of ethylenically unsaturated carboxylic acids with polyalkylene glycols, for example.

Suitable further ethylenically unsaturated monomers (MF3) include monomers containing siloxane groups, of the formula RSi(CH₃)₀₋₂(OR¹)₃₋₁, where R has the definitions CH₂═CR²—(CH₂)₀₋₁ or CH₂═CR²CO₂—(CH₂)₁₋₃, R¹ is an unbranched or branched, optionally substituted alkyl radical having 3 to 12 carbon atoms, which can if desired be interrupted by an ether group, and R² is H or CH₃.

Preference is given to silanes of the formulae CH₂═CR²—(CH₂)₀₋₁Si(CH₃)₀₋₁(OR¹)₃₋₂ and CH₂═CR²CO₂—(CH₂)₃Si(CH₃)₀₋₁(OR¹)₃₋₂, where R¹ is a branched or unbranched alkyl radical having 1 to 8 carbon atoms and R² is H or CH₃.

Particularly preferred silanes are vinylmethyldimethoxysilane, vinylmethyldiethoxysilane, vinylmethyldi-n-propoxysilane, vinylmethyldiiso-propoxysilane, vinylmethyldi-n-butoxysilane, vinylmethyldi-sec-butoxy-silane, vinylmethyldi-tert-butoxysilane, vinylmethyldi(2-methoxyisopropyl-oxy)silane, and vinylmethyldioctyloxysilane.

Particular preference is given to silanes of the formula CH₂═CR²—(CH₂)₀₋₁Si(OR¹)₃ and CH₂═CR²CO₂—(CH₂)₃(OR¹)₃, where R¹ is a branched or unbranched alkyl radical having 1 to 4 carbon atoms and R² is H or CH₃. Examples thereof are γ-(meth)acryloyloxypropyltris(2-meth-oxyethoxy)silane, γ-(meth)acryloyloxypropyltrismethoxysilane, γ-(meth)-acryloyloxypropyltrisethoxysilane, γ-(meth)acryloyloxypropyltris-n-prop-oxysilane, γ-(meth)acryloyloxypropyltrisisopropoxysilane, γ-(meth)acryloyl-oxypropyltrisbutoxysilane, γ-acryloyloxypropyltris(2-methoxyethoxy)silane, γ-acryloyloxypropyltrismethoxysilane, γ-acryloyloxypropyltrisethoxysilane, γ-acryloyloxypropyltris-n-propoxysilane, γ-acryloyloxypropyltrisisopropoxy-silane, γ-acryloyloxypropyltrisbutoxysilane, and also vinyltris(2-methoxy-ethoxy)silane, vinyltrismethoxysilane, vinyltrisethoxysilane, vinyltris-n-propoxysilane, vinyltrisisopropoxysilane and vinyltrisbutoxysilane. The stated silane compounds can if desired also be used in the form of their (partial) hydrolysates.

Additionally suitable as further ethylenically unsaturated monomers (MF3) are nitriles of α,β-monoethylenically unsaturated C₃-C₈ carboxylic acids, such as acrylonitrile and (meth)acrylonitrile, for example, and also adhesion-improving and crosslinking monomers. It is also possible to use C₄-C₈ conjugated dienes, such as 1,3-butadiene, isoprene, and chloroprene, for example, as monomers (M6).

The adhesion-improving monomers include not only compounds which have an acetoacetoxy unit bonded covalently to the double bond system but also compounds having covalently bonded urea groups. The first-mentioned compounds include in particular acetoacetoxy ethyl (meth)acrylate and allyl acetoacetate. The compounds containing urea groups include for example N-vinylurea and N-allylurea and also derivatives of imidazolidin-2-one, such as N-vinyl- and N-allylimidazolidin-2-one, N-vinyloxyethylimidazolidin-2-one, N-(2-(meth)acrylamidoethyl)-imidazolidin-2-one, N-(2-(meth)acryloyloxyethyl)imidazolidin-2-one, N-(2-(meth)acryloyloxyacetamidoethyl)imidazolidin-2-one, and also other adhesion promoters known to the skilled worker and based on urea or imidazolidin-2-one. Additionally suitable for improving the adhesion is diacetoneacrylamide in combination with the subsequent addition of adipic dihydrazide to the dispersion. The adhesion-promoting monomers can be used where appropriate in amounts of from 0.1 to 10% by weight, preferably from 0.5 to 5% by weight, based on the total amount of the monomers. Preferably, however, the copolymers do not contain any of these adhesion-promoting monomers in copolymerized form.

As crosslinking monomers it is possible to use not only difunctional but also polyfunctional monomers. Examples thereof are diallyl phthalate, diallyl maleate, triallyl cyanurate, tetraallyloxyethane, divinylbenzene, butane-1,4-diol di(meth)acrylate, triethylene glycol di(meth)acrylate, divinyl adipate, allyl(meth)acrylate, vinyl crotonate, methylenebisacrylamide, hexanediol diacrylate, pentaerythritol diacrylate, and trimethylolpropane triacrylate. The crosslinking monomers can be used where appropriate in amounts of from 0.02 to 5% by weight, preferably from 0.02 to 1% by weight, based on the total amount of the monomers.

The selection of the suitable monomers or monomer combinations must take account of the generally recognized considerations relating to the preparation of dispersions which are used for preparing coating materials. Thus in particular it should be ensured that polymers are formed which form a film under the envisaged drying conditions of the coating, and that the selection of the monomers for preparing copolymers is made such that in accordance with the position of the polymerization parameters the formation of copolymers can be expected. Some preferred monomer combinations are listed below:

Preferred monomer mixtures from the monomers M for preparing copolymers are vinyl acetate/vinyl chloride/ethene, vinyl acetate/vinyl laurate/ethene, vinyl acetate/vinyl laurate/ethene/vinyl chloride, vinyl acetate/Versatic acid vinyl ester/ethene/vinyl chloride, Versatic acid vinyl ester/ethene/vinyl chloride, vinyl acetate/Versatic acid vinyl ester/ethene, and vinyl acetate/ethene, particular preference being given to the combination vinyl acetate/ethene. Further of preference are vinyl acetate/butyl acrylate, vinyl acetate/dibutyl maleate, vinyl acetate/dibutyl fumarate, vinyl acetate/2-ethylhexyl acrylate, vinyl acetate/ethene/butyl acrylate, vinyl acetate/ethene/dibutyl maleate, vinyl acetate/ethene/dibutyl fumarate, vinyl acetate/ethene/2-ethylhexyl acrylate, methyl methacrylate/butyl acrylate, methyl methacrylate/2-ethylhexyl acrylate, styrene/butyl acrylate, styrene/2-ethylhexyl acrylate, methyl methacrylate/isobutyl acrylate, and methyl methacrylate/isopropyl acrylate.

Particular preference is given to monomer mixtures which include vinyl esters, since they can be prepared more easily and with a greater breadth of variation in the presence of hydroxyl-containing protective colloids than can corresponding monomer mixtures which do not include any vinyl ester components.

The dispersion used in accordance with the invention comprises at least one protective colloid and if desired at least one emulsifier. The protective colloids are polymeric compounds, having molecular weights of more than 2000 g/mol for example, whereas the emulsifiers are low molecular weight compounds whose relative molecular weights are below 2000 g/mol, for example.

The dispersion used in accordance with the invention comprises hydroxyl-containing protective colloids distinctive in that they contain ethylenically unsaturated radicals.

The amounts used of hydroxyl-containing protective colloid containing ethylenically unsaturated radicals are 0.05-25% by weight, preferably 0.1-20% by weight, more preferably 0.2-15% by weight, with particular preference 0.3-10% by weight, and very preferably 0.4-5% by weight, based on the total mass of the monomers used to prepare the dispersion.

It is preferred to employ hydroxyl-containing protective colloids at least some of whose hydroxyl groups are substituted by ethylenically unsaturated radicals.

Particular preference is given to hydroxyl-containing cellulose ethers at least some of whose hydroxyl groups are substituted by ethylenically unsaturated radicals. Cellulose ethers are obtainable, as is known, by etherification or alkylation of cellulose molecules. Cellulose molecules are constructed of anhydroglucose units, there being in each anhydroglucose unit three hydroxyl groups which can be reacted with the etherifying and/or alkylating reagents and/or further compounds, all of which are known to the skilled worker, to form mixed cellulose ethers and/or substituted cellulose ethers.

The cellulose ethers are characterized conventionally using the terms DS (degree of substitution) and MS (degree of molar substitution), with DS giving the average number of substituted hydroxyl groups in the cellulose per anhydroglucose unit and MS giving the average number of moles of the reactant combined with the cellulose/cellulose ether per mole of anhydroglucose unit.

Examples of hydroxyl-containing cellulose ethers at least some of whose hydroxyl groups are substituted by ethylenically unsaturated radicals can be found in a series of laid-open specifications, such as in DE-A-40 15 158, DE-A-41 33 677, DE-A-197 51 712, and DE-A-197 08 531, for example, which disclose cellulose ethers containing alkenyl groups, such as cellulose ethers containing propenyl and butenyl groups, for example.

Particular preference is given to hydroxyl-containing cellulose ethers having an MS of unsaturated radicals R_{unsaturated} of from 0.001 to 1.0, preferably from 0.003 to 0.5, very preferably from 0.01 to 0.06, and more preferably still from 0.02 to 0.04.

The cellulose ethers may be synthesized for example from methylcellulose, hydroxyethylcellulose, hydroxypropylcellulose, dihydroxypropylcellulose, carboxymethylcellulose, the esters and salts thereof with sodium, potassium, calcium, and ammonium ions, sulfoethylcellulose, methylhydroxyethylcellulose, methylhydroxypropylcellulose, methyl-dihydroxypropylcellulose, methylcarboxymethylcellulose, methylsulfoethyl-cellulose, ethylhydroxyethylcellulose, ethylhydroxypropylcellulose, ethyldihydroxypropylcellulose, ethylcarboxymethylcellulose, ethylsulfoethyl-cellulose, ethylhydroxyethylcellulose, dihydroxypropylcellulose, sulfoethyl-carboxymethylcellulose, dihydroxypropylsulfoethylcellulose, hydroxyethyl-sulfoethylcellulose, dihydroxypropylhydroxyethylcellulose, dihydroxypropyl-carboxymethylcellulose, and hydroxyethylcarboxymethylcellulose.

Suitable unsaturated radicals R_{unsaturated} include in principle all radicals which contain double bond systems and which can be copolymerized free-radically with the monomers (M). Thus, for example, R_{unsaturated} may be an alkenyl radical having more than 2 carbon atoms, such as propenyl or butenyl, for example. In addition it is also possible to use substituted mixed cellulose ethers where R_{unsaturated} is C(O)CR¹═CHR², C(O)CR³═CR⁴C(O)OR⁵, where R¹, R², R³, and R⁴═H or Me and R⁵═H, C₁-C₈ alkyl or sodium, potassium, or ammonium.

In one particularly preferred embodiment propenyl-substituted and butenyl-substituted cellulose ethers of the hydroxyethylcellulose, hydroxypropylcellulose, dihydroxyethylcellulose, and dihydroxyethyl-hydroxyethylcellulose type having an MS_{propenyl} and/or butenyl of from 0.001 to 1.0, preferably from 0.003 to 0.5, very preferably from 0.01 to 0.06, and more preferably still from 0.02 to 0.04 are used.

As hydroxyl-containing protective colloids at least some of whose hydroxyl groups are substituted by ethylenically unsaturated radicals it is preferred, in addition to the stated cellulose ethers, also to use polyvinyl alcohols at least some of whose hydroxyl groups are substituted by ethylenically unsaturated radicals, as disclosed for example in JP 1999/188,576.

It is also possible to use mixtures of two or more such protective colloids.

Alternatively use may also be made in addition of other protective colloids, such as the natural substances starch, gum arabic, alginates or gum tragacanth, modified natural substances such as methyl-, ethyl-, hydroxyethyl- or carboxymethylcellulose, or starch modified by means of saturated acids or epoxides, and also synthetic substances such as polyvinyl alcohol (with or without residual acetyl content) or partly esterified or acetalized polyvinyl alcohol or polyvinyl alcohol etherified with saturated radicals, and also polypeptides, such as gelatin, and additionally polyvinylpyrrolidone, polyvinylmethylacetamide or poly(meth)acrylic acid.

The weight fraction of such additional, other protective colloids, present optionally, based on the total amount of the monomers used for the preparation, is normally up to 15%.

Furthermore, in many cases it can be advantageous during the preparation of the dispersions to use, in addition to the protective colloids, nonionic and/or ionic emulsifiers, which may contribute to increasing the latex stability, among other things.

Suitable nonionic emulsifiers are araliphatic and aliphatic nonionic emulsifiers, such as ethoxylated mono-, di-, and trialkylphenols (EO units: 3 to 50, alkyl radical: C₄ to C₉), ethoxylates of long-chain alcohols (EO units: 3 to 50, alkyl radical: C₈ to C₃₆), and polyethylene oxide/polypropylene oxide block copolymers, for example. Preference is given to ethoxylates of long-chain alkanols (alkyl radical: C₁₀ to C₂₂, average degree of ethoxylation: 3 to 50) and, of these, particular preference to those based on naturally occurring alcohols, Guerbet alcohols or oxo alcohols having a linear or branched C₁₂-C₁₈ alkyl radical and a degree of ethoxylation of from 8 to 50.

Further suitable emulsifiers can be found in Houben-Weyl, Methoden der organischen Chemie, volume XIV/1, Makromolekulare Stoffe [Macromolecular compounds], Georg-Thieme-Verlag, Stuttgart, 1961, pp. 192-208.

Suitable ionic emulsifiers include both anionic and cationic emulsifiers.

The anionic emulsifiers include alkali metal and ammonium salts of alkyl sulfates (alkyl radical: C₈ to C₁₈), alkylphosphonates (alkyl radical: C₈ to C₁₈), of sulfuric monoesters or phosphoric monoesters and diesters with ethoxylated alkanols (EO units: 2 to 50, alkyl radical: C₈ to C₂₂) and with ethoxylated alkylphenols (EO units: 3 to 50, alkyl radical: C₄ to C₉), of alkylsulfonic acids (alkyl radical: C₁₂ to C₁₈), of alkylarylsulfonic acids (alkyl radical: C₉ to C₁₈), of sulfosuccinic monoesters and sulfosuccinic diesters of alkanols (alkyl radical: C₈ to C₂₂) and ethoxylated alkanols (EO units: 2 to 50, alkyl radical: C₈ to C₂₂), and of nonethoxylated and ethoxylated alkylphenols (EO units: 3 to 50, alkyl radical: C₄ to C₉). In general the emulsifiers listed are used in the form of technical-grade mixtures, with the figures for the length of alkyl radical and EO chain referring to the respective maximum of the distributions occurring in the mixtures. Examples from the stated classes of emulsifier are ®Texapon K12 (sodium lauryl sulfate from Cognis), ®Emulsogen EP (C₁₃-C₁₇ alkylsulfonate from Clariant), ®Maranil A 25 IS (sodium n-alkyl(C₁₀-C₁₃)benzenesulfonate from Cognis), ®Genapol liquid ZRO (sodium C₁₂/C₁₄ alkyl ether sulfate with 3 EO units from Clariant), ®Hostapal BVQ-4 (sodium salt of a nonylphenyl ether sulfate with 4 EO units from Clariant), Aerosol MA 80 (sodium dihexylsulfosuccinate from Cytec Industries), Aerosol A-268 (disodium isodecylsulfosuccinate from Cytec Industries), and Aerosol A-103 (disodium salt of a monoester of sulfosuccinic acid with an ethoxylated nonylphenyl from Cytec Industries).

Additionally suitable are compounds of the formula 1, 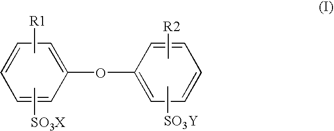
in which R¹ and R² are hydrogen or C₄-C₂₄ alkyl, preferably C₆-C₁₆ alkyl, and are not simultaneously hydrogen, and X and Y are alkali metal ions and/or ammonium ions. Frequently in the case of these emulsifiers use is also made of technical-grade mixtures, which contain a fraction of from 50 to 90% by weight of the monoalkylated product, an example being Dowfax® 2A1 (R¹═C₁₂ alkyl; DOW Chemical). The compounds are general knowledge, from U.S. Pat. No. 4,269,749, for example, and are available commercially.

Additionally suitable as ionic emulsifiers are gemini surfactants, also known to the skilled worker, as are described in, for example, the essay “Gemini-Tenside” by F. M. Menger and J. S. Keiper (Angew. Chem. 2000, pp. 1980-1996) and the publications cited therein.

The cationic emulsifiers include for example alkylammonium acetates (alkyl radical: C₈ to C₁₂), quaternary compounds containing ammonium groups, and pyridinium compounds.

Regarding the choice of ionic emulsifiers it must of course be ensured that incompatibilities in the resulting polymer dispersion, which can lead to coagulation, are ruled out. It is therefore preferred to use anionic emulsifiers in combination with anionic monomers or cationic emulsifiers in combination with cationic monomers, the combinations of anionic emulsifiers and anionic monomers being particularly preferred.

Furthermore, it is possible to use both ionic and nonionic emulsifiers which as an additional functionality include one or more unsaturated double bond units and which can be incorporated into the forming polymer chains during the polymerization process. These compounds, referred to as copolymerizable emulsifiers (“surfmers”), are general knowledge to the skilled worker. Examples can be found in a series of publications (e.g.: “Reactive surfactants in heterophase polymerization” by A. Guyot et al. in Acta Polym. 1999, pp. 57-66) and are available commercially (e.g., ®Emulsogen R 208 from Clariant or Trem LF 40 from Cognis).

The amounts of the emulsifiers, where used, are within the usual limits observed. All in all, therefore, up to about 10% by weight, preferably up to 5% by weight, based on the total amount of the monomers used for preparing the dispersions, is used. Generally speaking, mixtures of ionic and nonionic emulsifiers are used, although it is also possible to use ionic and nonionic emulsifiers alone for additional stabilization of the dispersions.

Suitable free-radical polymerization initiators for starting and continuing the polymerization during the preparation of the dispersions include all known initiators which are capable of starting a free-radical aqueous polymerization, preferably an emulsion polymerization. They may be peroxides, such as alkali metal peroxodisulfates, for example, or azo compounds. As polymerization initiators it is also possible to use what are called redox initiators, which are composed of at least one organic and/or inorganic reducing agent and at least one peroxide and/or hydroperoxide, such as tert-butyl hydroperoxide, for example, with sulfur compounds, such as the sodium salt of hydroxymethanesulfinic acid, sodium sulfite, sodium disulfite, sodium thiosulfate, and acetone-bisulfite adduct, for example, or hydrogen peroxide with ascorbic acid; as further reducing agents, which may form radicals with peroxides, it is also possible to use reducing sugars. Use may also be made of combined systems, which include a small amount of a metal compound which is soluble in the polymerization medium and whose metallic component is able to exist in a plurality of valence states, such as ascorbic acid/iron (II) sulfate/hydrogen peroxide, for example, in which ascorbic acid may frequently be replaced by the sodium salt of hydroxymethanesulfinic acid, acetone-bisulfite adduct, sodium sulfite, sodium hydrogen sulfite or sodium bisulfite, and hydrogen peroxide by organic peroxides such as tert-butyl hydroperoxide or alkali metal peroxodisulfates and/or ammonium peroxodisulfate, for example. Instead of said acetone-bisulfite adduct it is also possible to use other bisulfite adducts known to the skilled worker, such as those described, for example, in EP-A-0 778 290 and in the references cited therein. Further preferred initiators are peroxodisulfates, such as sodium peroxodisulfate, for example. The amount of the free-radical initiator systems used, based on the total amount of the monomers to be polymerized, is preferably from 0.05 to 2.0% by weight.

The molecular weight of the homopolymers and/or copolymers of the dispersions can be adjusted by adding small amounts of one or more molecular weight regulator substances. These regulators are used generally in an amount of up to 2% by weight, based on the monomers to be polymerized. As regulators it is possible to use all of the substances which are known to the skilled worker. Preference is given, for example, to organic thio compounds, silanes, allyl alcohols, and aldehydes.

The dispersion may further comprise a number of other substances, such as plasticizers, preservatives, pH modifiers and/or defoamers, for example.

The preparation of the aqueous polymer dispersions which are suitable in accordance with the invention is not critical. Thus the emulsion polymerization which is preferably carried out, or another method of polymerization, such as suspension or solution polymerization, can take place either batchwise or alternatively and preferably by semicontinuous processes. In the case of the semicontinuous processes the major amount, i.e., at least 70% by weight, preferably at least 90% by weight, of the monomers to be polymerized is supplied to the polymerization batch continuously, including by staged or gradient procedures. This procedure is also referred to as a monomer feed process, in which the term “monomer feed” refers to the metered addition of gaseous monomers, liquid monomer mixtures, monomer solutions or, in particular, aqueous monomer emulsions. The individual monomers can be metered by means of separate feeds. In addition it is also possible, of course, to carry out the metering of the monomers in a manner such that the mixture of the metered monomer compositions is varied in such a way that the resulting polymer contains different polymer phases, something which is manifested, for example, in the appearance of more than one glass transition temperature when the dry polymer is analyzed by means of differential scanning calorimetry.

In addition to the seed-free preparation mode it is also possible, in order to set a defined polymer particle size, for the emulsion polymerization to take place by the seed latex process or in the presence of seed latices produced in situ. Such processes are known and are described at length in a multiplicity of patent applications (e.g., EP-A-0 040 419 and EP-A-0 567 812) and publications (Encyclopedia of Polymer Science and Technology, Vol. 5, John Wiley & Sons Inc., New York 1966, p. 847).

Following the actual polymerization reaction it may be desirable and/or necessary largely to free the aqueous polymer dispersions, suitable for the purposes of the invention, from odorous substances, such as residual monomers and other volatile organic constituents, for example. This can be done in conventional manner physically, for example, by distillative removal (in particular by way of steam distillation) or by stripping with an inert gas. The lowering of the residual monomer content can also be effected chemically by means of free-radical postpolymerization, in particular by the action of redox initiator systems, as described for example in DE-A-44 35 423. Preference is given to postpolymerization with a redox initiator system comprising at least one organic peroxide and an organic and/or inorganic sulfite. Particular preference is given to a combination of physical and chemical methods, in which case after the residual monomer content has been lowered by chemical postpolymerization it is lowered further by means of physical methods to preferably <1000 ppm, more preferably <500 ppm, in particular <100.

The further ingredients present if desired in the aqueous coating compositions of the invention with binder are guided by the particular desired field of use.

The aqueous coating materials of the invention, with binder, can in fact be employed, for example, as primers, clear coating materials, adhesives or else food coatings. In these cases these coating materials comprise, where appropriate, rheology-modifying additives and/or further components, such as defoamers, antislip additives, color pigments, antimicrobial preservatives, plasticizers, and film-forming auxiliaries, all of which are known to the skilled worker.

A further preferred embodiment of the present invention are pigmented aqueous coating materials with binder.

These preferred pigmented coating materials, with particular preference emulsion paints, contain in general from 30 to 75% by weight, preferably from 40 to 65% by weight, of nonvolatile constituents. These are all constituents of the coating material with the exception of water, but at least the total amount of solid binder, filler, pigment, and auxiliaries, such as plasticizers, rheology modifier, preservatives or defoamers.

The nonvolatile constituents include preferably
a) from 3 to 90% by weight, more preferably from 10 to 60% by weight, of the solids content of the at least one binder,
b) from 5 to 85% by weight, more preferably from 10 to 60% by weight, of at least one pigment,
c) from 0 to 85% by weight, more preferably from 20 to 70% by weight, of at least one filler, and
d) from 0.05 to 40% by weight, more preferably from 0.5 to 15% by weight, of customary auxiliaries.

Particular preference is given to solvent-free and plasticizer-free aqueous coating materials.

The pigment volume concentration (PVC) of the pigmented aqueous coating materials of the invention with binder is generally above 5%, preferably in the range from 10 to 90%. In particularly preferred embodiments the PVCs are either in the range from 10 to 45% or in the range from 60 to 90%, in particular from 70 to 90%.

As pigments it is possible to use any of the pigments known to the skilled worker for the stated end use. Preferred pigments for the aqueous coating materials of the invention with binder, preferably for emulsion paints, are titanium dioxide, preferably in the rutile form, barium sulfate, zinc oxide, zinc sulfide, basic lead carbonate, antimony trioxide, and lithopones (zinc sulfide and barium sulfate), for example. It is, however, also possible for the aqueous formulations to include colored pigments, examples being iron oxides, carbon black, graphite, luminescent pigments, zinc yellow, zinc green, ultramarine, manganese black, antimony black, manganese violet, Paris blue or Schweinfurt green. Besides the inorganic pigments, the formulations of the invention may also comprise organic color pigments, examples being sepia, gamboge, Cassel brown, toluidine red, Para red, Hansa yellow, indigo, azo dyes, anthraquinoid and indigoid dyes, and also dioxazine, quinacridone, phthalocyanine, isoindolinone, and metal complex pigments.

As fillers it is possible to use any of the fillers known to the skilled worker for the stated end use. Preferred fillers are aluminosilicates, such as feldspars, silicates, such as kaolin, talc, mica, and magnesite, alkaline earth metal carbonates, such as calcium carbonate, in the form for example of calcite or chalk, magnesium carbonate, dolomite, alkaline earth metal sulfates, such as calcium sulfate, and silicon dioxide. The fillers can be used either as individual components or as filler mixtures. Preference is given in the art to filler mixtures such as calcium carbonate/kaolin and calcium carbonate/talc, for example. Synthetic-resin-bound plasters may also include relatively coarse aggregates, such as sands and sandstone granules.

In emulsion paints preference is generally given to finely divided fillers. In order to increase the hiding power and to save on the use of white pigments it is common in emulsion paints frequently to use finely divided fillers, such as precipitated calcium carbonate or mixtures of different calcium carbonates with different particle sizes, for example. To adjust the hiding power, the shade, and the depth of color it is preferred to use blends of color pigments and fillers.

The usual auxiliaries include wetting agents or dispersants, such as sodium, potassium or ammonium polyphosphates, alkali metal salts and ammonium salts of polyacrylic acids and of polymaleic acid, polyphosphonates, such as sodium 1-hydroxyethane-1,1-diphosphonate, and also salts of naphthalenesulfonic acid, particularly the sodium salts thereof. As dispersants it is additionally possible to use suitable amino alcohols, such as 2-amino-2-methylpropanol, for example. The dispersants and wetting agents are used preferably in an amount of from 0.1 to 2% by weight, based on the total weight of the emulsion paint.

The auxiliaries may further comprise thickeners, examples being cellulose derivatives, such as methylcellulose, hydroxyethylcellulose, and carboxymethylcellulose, and also caseine, gum arabic, gum tragacanth, starch, sodium alginate, polyvinyl alcohol, polyvinylpyrrolidone, sodium polyacrylates, water-soluble copolymers based on acrylic and (meth)acrylic acid, such as acrylic acid/acrylamide copolymers and (meth)acrylic acid/acrylic ester copolymers, and what are called associative thickeners, such as styrene-maleic anhydride polymers or, preferably, the following, which are known to the skilled worker: hydrophobically modified polyether urethanes (HEUR), hydrophobically modified acrylic acid copolymers (HASE), and polyether polyols.

Inorganic thickeners as well, such as bentonites or hectorite, for example, can be used.

The thickeners are used preferably in amounts of from 0.1 to 3% by weight, more preferably from 0.1 to 1% by weight, based on the total weight of the aqueous coating material.

The aqueous coating materials of the invention may also comprise crosslinking additives. Additives of this kind may be the following: aromatic ketones, such as alkyl phenyl ketones, which if desired have one or more substituents on the phenyl ring, or benzophenone and substituted benzophenones as photoinitiators. Photoinitiators suitable for this purpose are disclosed for example in DE-A-38 27 975 and EP-A-0 417 568. Suitable compounds with a crosslinking action are also water-soluble compounds containing at least two amino groups, examples being dihydrazides of aliphatic dicarboxylic acids, as disclosed for example in DE-A-39 01 073, if monomers containing carbonyl groups have been copolymerized in the preparation of the aqueous polymer dispersion suitable in accordance with the invention.

As auxiliaries in the aqueous coating compositions of the invention it is also possible, moreover, to use waxes based on paraffins and polyethylene, and also dulling agents, defoamers, preservatives or hydrophobicizers, biocides, fibers, and further additives known to the skilled worker.

The pigmented aqueous coating materials of the invention may of course also comprise solvents and/or plasticizers as film-forming auxiliaries. Film-forming auxiliaries are general knowledge to the skilled worker and can be used normally in amounts of from 0.1 to 20% by weight, based on the solid binder present in the coating material, so that the aqueous coating material has a minimum film-forming temperature of less than 15° C., preferably in the range from 0 to 10° C.

The present invention further provides the thixotropic coating materials obtainable following the addition of a thixotropic agent, in particular of metal chelates, from the aqueous coating compositions of the invention with binder.

Suitable metal chelates are the compounds normally used for thixotroping purposes in aqueous emulsion paints, these compounds deriving primarily from titanium and zirconium.

Suitable titanium chelates are the reaction products of isopropyl, n-butyl, and other low molecular weight ortho-esters of titanic acid with one or more compounds from at least one of the following classes of substance:
1. glycols containing at least two free hydroxyl groups, such as the alkylene glycols 1,2-ethanediol (ethylene glycol), 1,2-propanediol, 1,3-propanediol, 1,2-butylene glycol, and 2-methyl-2,4-pentanediol;
2. glycol ethers containing at least one free hydroxyl group, such as the monoalkyl ethers of an alkylene glycol having up to 6 carbon atoms. Examples of such glycol ethers are C₁-C₄ monoalkyl ethers of ethylene glycol, diethylene glycol or of triethylene glycol, such as 2-methoxyethanol, 2-ethoxyethanol, 2-isopropoxyethanol and 2-n-butoxyethanol;
3. alkanolamines, a class which embraces mono-, di-, and trialkanolamines. Typical alkanolamines are monoethanolamine, diethanolamine, triethanolamine, diisopropanolamine, triisopropanol-amine, methyldiethanolamine, β-aminoethylethanolamine, and 2-amino-2-ethyl-1,3-propanediol;
4. alpha-hydroxy carboxylic acids, such as hydroxy monocarboxylic acids and hydroxy dicarboxylic acids, which can contain one or more hydroxyl groups per molecule, subject to the proviso that there is at least one hydroxyl group positioned alpha to the carboxyl group, such as lactic acid, glyoxylic acid, or tartaric acid, for example;
5. beta-keto-carbonyl compounds, such as β-diketones and β-keto-carboxylic acids. One compound from this class of substance which is frequently used is acetylacetone, for example.

In general there is no need to isolate the reaction products in pure form; that is, the chelates formed can remain in solution in the liberated alcohol. Although the liberated alcohol can be separated off by distillation, the products obtained are in some cases of high viscosity and are therefore difficult to handle.

In many cases the titanium chelates are reaction products with only one compound from only one of the stated classes of substance; thus water-soluble titanium complexes of alpha-hydroxy acids and their barium, calcium, strontium or magnesium salts, and their preparation, are described in GB-A 811 524 and U.S. Pat. No. 2,453,520. In contrast, however, GB-A 2 207 434 also discloses titanium chelates which have a retarded gel effect and which are derived from the reaction of titanic acid with a combination of glycols/glycol ethers, alkanolamines, and α-hydroxy carboxylic acids.

Particular preference is given to the titanium chelates prepared from the reaction of titanic acid with alkanolamines. Examples of these widespread thixotropic agents are, among others, the commercially available products Vertec® AT23 and Vertec® AT33.

Suitable zirconium compounds are, for example, the thixotroping agents prepared by reacting zirconyl carbonate with acetic acid, methacrylic acid or coconut oil fatty acid, and isopropanol, which are described in U.S. Pat. No. 3,280,050, for example.

Thixotroping agents of this kind can be added to the coating materials of the invention in amounts between 0.05 and 5% by weight, preferably from 0.1 to 2% by weight, based on the total amount of the coating material. The thixotroping agents can also, if desired, be added to any pigment pastes employed in the course of the preparation of pigmented aqueous thixotropic coating materials, in which case they are added immediately prior to blending with the polymer dispersion.

The rheology aimed at in accordance with the invention for the aqueous thixotropic coating material, with or without pigment, is not usually established immediately after all of the ingredients necessary for this property have been combined, but only over the course of a number of hours, in some cases only after days, and is reinforced further in the course of storage. Generally speaking, 24 hours after the aqueous thixotropic coating material has been finished, thickening has progressed to a point where all of the target performance advantages are already very much present, and the state in which there are no longer any substantial changes in rheology is attained after about 10 to 14 days.

The aqueous coating materials of the invention are stable, fluid systems which can be used for coating and/or adhesively bonding a multiplicity of substrates. Consequently the present invention also relates to methods of coating and/or adhesively bonding substrates and also to the coating materials, including the adhesives, themselves. Examples of suitable substrates include wood, concrete, metal, glass, ceramics, plastics, plasters, wall coverings, paper, and painted, primed or weathered substrates. The application of the coating material to the target substrate takes place in a way which is dependent on the form of the coating material. Depending on the viscosity and the pigment content of the coating material, and also on the substrate, application may take place by means of rollers, brushes, doctor blades or nozzles, or in the form of a spray.

The invention is described in more detail below, with reference to examples, without being thereby restricted in any way whatsoever.

I. Preparation and Characterization of Dispersions

The vinyl acetate/ethylene dispersions prepared as part of the examples are implemented in a 70 l pressure-rated autoclave with jacket cooling and a permissible pressure range of up to 160 bar. The preparation of the vinyl acetate/VeoVa10/butyl acrylate dispersions takes place in a 3 l glass reactor. The parts and percentages used in the examples below are by weight, unless noted otherwise.

The viscosity of the dispersions is determined using a Haake rotational viscometer (Rheomat® VT 500) at room temperature with a shear gradient of 17.93 s⁻¹.

The mean particle size and the particle size distribution are determined by laser and white light aerosol spectroscopy. The stated particle sizes correspond to the particle diameter after drying.

The residual monomer amounts reported in the examples are determined by gas chromatography (GC).

The minimum film-forming temperature (MFFT) of the polymer dispersions is determined on the basis of Ullmanns Enzyklopädie der technischen Chemie, 4th ed. vol. 19, VCH Weinheim 1980, p. 17. The measuring apparatus used is what is called a film formation bar, and is composed of a metal plate to which a temperature gradient is applied and on which temperature sensors are mounted at various points for the purpose of temperature calibration, the temperature gradient being chosen so that one end of the film formation bar has a temperature above the anticipated MFFT and the other end has a temperature below the anticipated MFFT. The aqueous polymer dispersion is then applied to the film formation bar. In those regions of the film formation bar whose temperature lies above the MFFT, a clear film is formed on drying, while in the cooler regions cracks occur, and at lower temperatures still a white powder is formed. On the basis of the known temperature profile of the plate the MFFT is determined visually as the temperature at which there is a crack-free film for the first time.

The glass transition temperature of the individual polymerization stages is calculated in approximation by the Fox equation, taking into account the principal monomers. As a basis for the calculation the glass transition temperatures of the homopolymers corresponding to the individual monomers are used, these temperatures being described in Ullmann's Encyclopedia of Industrial Chemistry, VCH Weinheim, vol. A 21 (1992) p. 169 or in J. Brandrup, E. H. Immergut: Polymer Handbook 3rd ed., J. Wiley, New York 1989. For ethene a homopolymer glass transition temperature of 148 K is assumed (see J. Brandrup, E. H. Immergut: Polymer Handbook 3rd ed., J. Wiley, New York 1989, p. VI/214), for vinyl acetate a homopolymer glass transition temperature of 315 K (see Ullmann's Encyclopedia of Industrial Chemistry, VCH Weinheim, vol. A 21 (1992) p. 169), for vinyl versatate VeoVa®10 a homopolymer glass transition temperature of 315 K (see Ullmann's Encyclopedia of Industrial Chemistry, VCH Weinheim, vol. A 21 (1992) p. 169), and for butyl acrylate a homopolymer glass transition temperature of 315 K (see Ullmann's Encyclopedia of Industrial Chemistry, VCH Weinheim, vol. A 21 (1992) p. 169).

I.1 Preparation of Vinyl Ester-Acrylic Ester Copolymer Dispersions Using Hydroxyethylcellulose

### EXAMPLE A1

The monomer mixture used consists of 25% VeoVa®10 (vinyl ester of α-branched C10 carboxylic acids, Shell), 67% vinyl acetate, and 8% butyl acrylate. A 3-liter reactor with plane-ground joints and a lid is charged with 992.9 g of deionized water and, with stirring and at room temperature, 11.7 g of hydroxyethylcellulose (Tylose H20, Clariant GmbH) are added and dissolved. Thereafter the following are added in order:
2.92 g sodium acetate
175.2 g 20% strength solution of a nonylphenyl ethoxylate having 30 ethylene oxide units (®Arkopal N300, Clariant) in water
116.8 g monomer mixture

The emulsion is heated to a temperature of 70° C. over the course of 30 minutes, but when it reaches an internal temperature of 60° C. 51.4 g of the initiator solution I (10% strength sodium persulfate solution in water) are added. After a 15-minute waiting time at 70° C. 1051.3 g of monomer mixture are fed in over the course of 180 minutes via a dropping funnel.

After the end of monomer addition 24.5 g of the initiator solution 11 (5% strength sodium persulfate solution in water) are added and stirring is continued at an internal temperature of 70° C. for 120 minutes. Subsequently the dispersion is cooled. The properties of the dispersion are summarized in table 1.

### EXAMPLE A2

This dispersion is prepared as for example A1. Instead of 11.7 g of Tylose H20 23.4 g are used. The properties of the dispersion are summarized in table 1.

### EXAMPLE A3

This dispersion is prepared as for example A1. Instead of 11.7 g of Tylose H20 11.7 g of Tylose H200 (Clariant GmbH) are used. The properties of the dispersion are summarized in table 1.

### EXAMPLE A4

This dispersion is prepared as for example A1. Instead of 11.7 g of Tylose H20 23.4 g of Tylose H200 (Clariant GmbH) are used. The properties of the dispersion are summarized in table 1.

I.2 Preparation of Vinyl Ester-Ethene Copolymer Dispersion Using Allyl-Modified Hydroxyethylcellulose

### EXAMPLE A5

This dispersion is prepared as for example A1. Instead of 11.7 g of Tylose H20 11.7 g of Tylose HL 40 AM (Clariant GmbH) are used. The properties of the dispersion are summarized in table 1.

I.3 Preparation of Vinyl Ester-Ethene Copolymer Dispersion Using Hydroxyethylcellulose

### EXAMPLE A6

A 70 l pressure-rated reaction vessel with temperature regulator, stirrer mechanism, metering pumps, and metering means for gaseous ethene (mass through-flow measurement) is charged with a solution (initial charge) consisting of the following constituents:

| | |
|---|---|
| 14825 g | water |
| 88.55 g | sodium acetate |
| 594.5 g | 30% strength sodium ethenesulfonate solution in water |
| 70.45 g | sodium lauryl sulfate (® Texapon K12 granules, Cognis) |
| 5284 g | 20% strength solution of a nonylphenol ethoxylate having 30 |
| | ethylene oxide units (® Arkopal N300, Clariant) in water |
| 34.87 g | 1% strength solution of Fe(II)-SO₄ × 7H₂O in water |
| 7120 g | 5% strength solution of the hydroxyethylcellulose Natrosol |
| | 250 GR (Hercules) in water |

The pH of the initial charge is 7.1. The apparatus is freed from atmospheric oxygen by evacuating it twice and flushing with nitrogen. Evacuation is carried out a third time and then ethene is injected into the apparatus until the internal pressure of the reactor is 30 bar. Subsequently 1586 g of vinyl acetate and 2.82 g of ®Rongalit C (BASF) in solution in 208 g of water are metered in. The internal temperature is then raised to 60° C. When the internal temperature reaches 50° C. a mixture of 4.0 g of an aqueous 70% strength tert-butyl hydroperoxide solution and 208 g of water is metered in and cooling is carried out in order to remove the heat of reaction. When the internal temperature reaches 60° C. 30118 g of vinyl acetate, and also a solution of 25.4 g of ®Rongalit C in 2058 g of water and a mixture of 36.3 g of an aqueous 70% strength tert-butyl hydroperoxide solution and 2058 g of water, are metered in over the course of 360 minutes. The internal temperature is held at 60° C. throughout the metering time. The ethene supply remains open at an internal pressure of 30 bar until a total of 3522 g of ethene have been metered in. When all the metered additions are at an end a solution of 35.7 g of sodium peroxodisulfate in 832 g of water is added, the internal temperature is raised to 80° C., and when reaction is at an end, after a further hour, the mixture is cooled. The internal pressure in the reactor after cooling to 30° C. is 1.0 bar.

The properties of the dispersion are summarized in table 1.

### EXAMPLE A7

The dispersion is prepared as for the preparation of the dispersion described in example A6. In deviation therefrom the initial charge used is a solution consisting of the following constituents (pH=6.7):

| | |
|---|---|
| 8060 g | water |
| 88.55 g | sodium acetate |
| 594.5 g | 30% strength sodium ethenesulfonate solution in water |
| 70.45 g | sodium lauryl sulfate (® Texapon K12 granules, Cognis) |
| 5284 g | 20% strength solution of a nonylphenol ethoxylate having 30 |
| | ethylene oxide units (® Arkopal N300, Clariant) in water |
| 34.87 g | 1% strength solution of Fe(II)-SO₄ × 7H₂O in water |
| 14242 g | 5% strength solution of the hydroxyethylcellulose Natrosol |
| | 250 GR (Hercules) in water |

The internal pressure of the reactor after cooling to 30° C. is 1.5 bar.

The properties of the dispersion are summarized in table 1.

### EXAMPLE A8

The dispersion is prepared as for the preparation of the dispersion described in example A6. In deviation therefrom the initial charge used is a solution consisting of the following constituents (pH=7.1):

| | |
|---|---|
| 17343 g | water |
| 88.55 g | sodium acetate |
| 594.5 g | 30% strength sodium ethenesulfonate solution in water |
| 2439 g | 30% strength solution of a sodium C₁₃-C₁₇ alkylsulfonate in |
| | water (® Emulsogen EP, Clariant) |
| 34.87 g | 1% strength solution of Fe(II)-SO₄ × 7H₂O in water |
| 7120 g | 5% strength solution of the hydroxyethylcellulose Natrosol |
| | 250 GR (Hercules) in water |

The internal pressure of the reactor after cooling to 30° C. is 0.7 bar.

The properties of the dispersion are summarized in table 1.

### EXAMPLE A9

The dispersion is prepared as for the preparation of the dispersion described in example A6. In deviation therefrom the initial charge used is a solution consisting of the following constituents (pH=6.8):

| | |
|---|---|
| 10955 g | water |
| 88.55 g | sodium acetate |
| 594.5 g | 30% strength sodium ethenesulfonate solution in water |
| 2439 g | 30% strength solution of a sodium C₁₃-C₁₇ alkylsulfonate in |
| | water (® Emulsogen EP, Clariant) |
| 34.87 g | 1% strength solution of Fe(II)-SO₄ × 7H₂O in water |
| 14240 g | 5% strength solution of the hydroxyethylcellulose Natrosol |
| | 250 GR (Hercules) in water |

The internal pressure of the reactor after cooling to 30° C. is 1.0 bar.

The properties of the dispersion are summarized in table 1.

### EXAMPLE A10

Polymerization Stage 1:

A 70 l pressure-rated reaction vessel with temperature regulator, stirrer mechanism, metering pumps, and metering means for gaseous ethene (mass through-flow measurement) is charged with a solution (initial charge) consisting of the following constituents:

| | |
|---|---|
| 14825 g | water |
| 88.55 g | sodium acetate |
| 594.5 g | 30% strength sodium ethenesulfonate solution in water |
| 70.45 g | sodium lauryl sulfate (® Texapon K12 granules, Cognis) |
| 5284 g | 20% strength solution of a nonylphenol ethoxylate having 30 |
| | ethylene oxide units (® Arkopal N300, Clariant) in water |
| 34.87 g | 1% strength solution of Fe(II)-SO₄ × 7H₂O in water |
| 7120 g | 5% strength solution of the hydroxyethylcellulose Natrosol |
| | 250 GR (Hercules) in water |

The pH of the initial charge is 6.9. The apparatus is freed from atmospheric oxygen by evacuating it twice and flushing with nitrogen. Evacuation is carried out a third time and then a total of 350 g of ethene is injected into the apparatus; after this quantity of ethene has been metered in, the internal pressure of the reactor is approximately 7 bar. Subsequently the ethene supply is shut off and 3170 g of vinyl acetate and 2.82 g of ®Rongalit C (BASF) in solution in 208 g of water are metered in. Thereafter the internal temperature is raised to 60° C. When an internal temperature of 50° C. is reached a mixture of 4.0 g of an aqueous 70% strength tert-butyl hydroperoxide solution and 208 g of water is metered in and cooling is carried out in order to remove the heat of reaction. When the internal temperature reaches 60° C. 7133 g of vinyl acetate are metered in over 90 minutes and a solution of 9.1 g of ®Rongalit C in 669 g of water and a mixture of 12.9 g of an aqueous 70% strength tert-butyl hydroperoxide solution and 669 g of water are metered in over the course of 130 minutes. The internal temperature is held at 60° C. throughout the metering time. A sample of dispersion taken after the end of the metered additions of the initiator components has a residual vinyl acetate content <0.3% and a solids content of 31.2%.

Polymerization Stage 2:

After the end of metering of the initiator solutions of the first stage, the ethene valve is opened and at an internal temperature of 60° C. the internal pressure of the reactor is raised to 40 bar by metered addition of ethene. When the internal pressure of the reactor reaches 40 bar, at an internal temperature of 60° C., 21400 g of vinyl acetate, and also a solution of 18.8 g of ®Rongalit C in 1389 g of water and a mixture of 27.0 g of an aqueous 70% strength tert-butyl hydroperoxide solution and 1389 g of water, are metered in over the course of 270 minutes. The ethene supply remains open, at an internal pressure of 40 bar, until a further 3172 g of ethene have been metered in. When all the metered additions are at an end a solution of 35.7 g of sodium peroxodisulfate in 832 g of water is added, the internal temperature is raised to 80° C., and after the end of reaction, after a further hour, the mixture is cooled. The internal pressure of the reactor after cooling to 30° C. is 1.0 bar.

The properties of the dispersion are summarized in table 1.

### EXAMPLE A11

The dispersion is prepared as for the preparation of the dispersion described in example A10. In deviation therefrom the initial charge used is a solution consisting of the following constituents (pH=6.9):

| | |
|---|---|
| 8060 g | water |
| 88.55 g | sodium acetate |
| 594.5 g | 30% strength sodium ethenesulfonate solution in water |
| 70.45 g | sodium lauryl sulfate (® Texapon K12 granules, Cognis) |
| 5284 g | 20% strength solution of a nonylphenol ethoxylate having 30 |
| | ethylene oxide units (® Arkopal N300, Clariant) in water |
| 34.87 g | 1% strength solution of Fe(II)-SO₄ × 7H₂O in water |
| 14240 g | 5% strength solution of the hydroxyethylcellulose Natrosol |
| | 250 GR (Hercules) in water |

The internal pressure of the reactor after cooling to 30° C. is 1.7 bar.

The properties of the dispersion are summarized in table 1.

### EXAMPLE A12

The dispersion is prepared as for the preparation of the dispersion described in example A10. In deviation therefrom the initial charge used is a solution consisting of the following constituents (pH=6.9):

| | |
|---|---|
| 17343 g | water |
| 88.55 g | sodium acetate |
| 594.5 g | 30% strength sodium ethenesulfonate solution in water |
| 2439 g | 30% strength solution of a sodium C₁₃-C₁₇ alkylsulfonate in |
| | water (® Emulsogen EP, Clariant) |
| 34.87 g | 1% strength solution of Fe(II)-SO₄ × 7H₂O in water |
| 7120 g | 5% strength solution of the hydroxyethylcellulose Natrosol |
| | 250 GR (Hercules) in water |

The internal pressure of the reactor after cooling to 30° C. is 1.0 bar.

The properties of the dispersion are summarized in table 1.

### EXAMPLE A13

The dispersion is prepared as for the preparation of the dispersion described in example A10. In deviation therefrom the initial charge used is a solution consisting of the following constituents (pH=6.7):

| | |
|---|---|
| 10955 g | water |
| 88.55 g | sodium acetate |
| 594.5 g | 30% strength sodium ethenesulfonate solution in water |
| 2439 g | 30% strength solution of a sodium C₁₃-C₁₇ alkylsulfonate in |
| | water (® Emulsogen EP, Clariant) |
| 34.87 g | 1% strength solution of Fe(II)-SO₄ × 7H₂O in water |
| 14240 g | 5% strength solution of the hydroxyethylcellulose Natrosol |
| | 250 GR (Hercules) in water |

The internal pressure of the reactor after cooling to 30° C. is 1.5 bar.

The properties of the dispersion are summarized in table 1.

I.4 Preparation of Vinyl Ester-Ethene Copolymer Dispersion Using Allyl-Modified Hydroxyethylcellulose

### EXAMPLE A14

The dispersion is prepared as for the preparation of the dispersion described in example A6. In deviation therefrom the initial charge used is a solution consisting of the following constituents (pH=7.1):

| | |
|---|---|
| 14825 g | water |
| 88.55 g | sodium acetate |
| 594.5 g | 30% strength sodium ethenesulfonate solution in water |
| 70.45 g | sodium lauryl sulfate (® Texapon K12 granules, Cognis) |
| 5284 g | 20% strength solution of a nonylphenol ethoxylate having 30 |
| | ethylene oxide units (® Arkopal N300, Clariant) in water |
| 34.87 g | 1% strength solution of Fe(II)-SO₄ × 7H₂O in water |
| 7120 g | 5% strength solution of the allyl-modified |
| | hydroxyethylcellulose Tylose HL 40 YG2 AM in water |
| | (Clariant GmbH) |

The internal pressure of the reactor after cooling to 30° C. is 1.0 bar.

The properties of the dispersion are summarized in table 1.

### EXAMPLE A15

The dispersion is prepared as for the preparation of the dispersion described in example A6. In deviation therefrom the initial charge used is a solution consisting of the following constituents (pH=7.2):

| | |
|---|---|
| 17343 g | water |
| 88.55 g | sodium acetate |
| 594.5 g | 30% strength sodium ethenesulfonate solution in water |
| 2439 g | 30% strength solution of a sodium C₁₃-C₁₇ alkylsulfonate in |
| | water (® Emulsogen EP, Clariant) |
| 34.87 g | 1% strength solution of Fe(II)-SO₄ × 7H₂O in water |
| 7120 g | 5% strength solution of the allyl-modified |
| | hydroxyethylcellulose Tylose HL 40 YG2 AM in water |
| | (Clariant GmbH) |

The internal pressure of the reactor after cooling to 30° C. is 0.8 bar.

The properties of the dispersion are summarized in table 1.

### EXAMPLE A16

The dispersion is prepared as for the preparation of the dispersion described in example A10. In deviation therefrom the initial charge used is a solution consisting of the following constituents (pH=7.3):

| | | |
|---|---|---|
| 14825 | g | water |
| 88.55 | g | sodium acetate |
| 594.5 | g | 30% strength sodium ethenesulfonate solution in water |
| 70.45 | g | sodium lauryl sulfate (® Texapon K12 granules, Cognis) |
| 5284 | g | 20% strength solution of a nonylphenol ethoxylate having |
| | | 30 ethylene oxide units (® Arkopal N300, Clariant) in |
| | | water |
| 34.87 | g | 1% strength solution of Fe(II)-SO₄ × 7H₂O in water |
| 7120 | g | 5% strength solution of the allyl-modified hydroxyethyl- |
| | | cellulose Tylose HL 40 YG2 AM in water (Clariant GmbH) |

The internal pressure of the reactor after cooling to 30° C. is 1.5 bar.

The properties of the dispersion are summarized in table 1.

### EXAMPLE A17

The dispersion is prepared as for the preparation of the dispersion described in example A10. In deviation therefrom the initial charge used is a solution consisting of the following constituents (pH=7.3):

| | | |
|---|---|---|
| 17343 | g | water |
| 88.55 | g | sodium acetate |
| 594.5 | g | 30% strength sodium ethenesulfonate solution in water |
| 2439 | g | 30% strength solution of a sodium C₁₃-C₁₇ alkylsulfonate |
| | | in water (® Emulsogen EP, Clariant) |
| 34.87 | g | 1% strength solution of Fe(II)-SO₄ × 7H₂O in water |
| 7120 | g | 5% strength solution of the allyl-modified hydroxyethyl- |
| | | cellulose Tylose HL 40 YG2 AM in water (Clariant GmbH) |

The internal pressure of the reactor after cooling to 30° C. is 1.4 bar.

The properties of the dispersion are summarized in table 1.

TABLE 1
Dispersion properties

| | Stabilizing system of the dispersion | | | | | | | | |
|---|---|---|---|---|---|---|---|---|---|
| | Protective | Amount | Nonionic emulsifier | Ionic emulsifier | Viscosity | Mean particle | Solids | | MFFT |
| Dispersion | colloid^{a)} | [pphm^{b)}] | [pphm^{b)}] | [pphm^{b)}] | [mPas] | diameter [nm] | content [%] | Tg [° C.] | [° C.] |
| A1 | H20 | 1.0 | 3 | 0 | 255 | 214 | 49.1 | about 22 | 8 |
| A2 | H20 | 2.0 | 3 | 0 | 216 | 253 | 49.2 | about 22 | 8 |
| A3 | H200 | 1.0 | 3 | 0 | 295 | 248 | 49.3 | about 22 | 8 |
| A4 | H200 | 2.0 | 3 | 0 | 110 | 302 | 49.9 | about 22 | 8 |
| A5 | HL40 AM | 1.0 | 3 | 0 | 235 | 302 | 49.2 | about 22 | 8 |
| A6 | 250 GR | 1.0 | 3 | 0.2 | 825 | 197 | 53.0 | about 10 | 4 |
| A7 | 250 GR | 2.0 | 3 | 0.2 | 1180 | 228 | 53.7 | about 10 | 4 |
| A14 | HL40 AM | 1.0 | 3 | 0.2 | 420 | 288 | 53.4 | about 10 | 5 |
| A8 | 250 GR | 1.0 | 0 | 2.1 | 148 | 187 | 53.7 | about 10 | 5 |
| A9 | 250 GR | 2.0 | 0 | 2.1 | 720 | 230 | 53.5 | about 10 | 3 |
| A15 | HL40 AM | 1.0 | 0 | 2.1 | 156 | 277 | 52.7 | about 10 | 5 |
| A10 | 250 GR | 1.0 | 3 | 0.2 | 822 | 190 | 53.4 | about 2/31 | 5 |
| A11 | 250 GR | 2.0 | 3 | 0.2 | 1120 | 226 | 53.7 | about 2/31 | 3 |
| A16 | HL40 AM | 1.0 | 3 | 0.2 | 614 | 291 | 53.6 | about 2/31 | 3 |
| A12 | 250 GR | 1.0 | 0 | 2.1 | 143 | 220 | 53.5 | about 2/31 | 4 |
| A13 | 250 GR | 2.0 | 0 | 2.1 | 534 | 248 | 53.7 | about 2/31 | 5 |
| A17 | HL40 AM | 1.0 | 0 | 2.1 | 280 | 254 | 53.0 | about 2/31 | 4 |

a) hydroxyethylcelluloses: H20=Tylose H20, Clariant GmbH, H200=Tylose H200, Clariant GmbH; HL 40 AM=Tylose HL 40 AM, allyl-modified hydroxyethylcellulose from Clariant GmbH; 250 GR=Natrosol 250 GR, Hercules
b) pphm =amounts used in parts by weight per 100 parts by weight of monomer.
   II. Preparation of Emulsion Paints
   II.1 Preparation of Solventborne Gloss Paints

### EXAMPLES B1 TO B5

Solventborne gloss paints are formulated from the aqueous polymer dispersions A1 to A5. This is done by initially introducing the following constituents into a vessel:

| | | |
|---|---|---|
| 92.5 | g | water |
| 0.5 | g | hydroxyethylcellulose rheological assistant having a viscosity |
| | | of 30 mPas (determined as a 1.9% strength solution in water |
| | | at 25° C.); Tylose ® H 20 YG4; Clariant |
| 4.0 | g | 10% strength by weight solution of a sodium polyphosphate in |
| | | water, Calgon ®; BK Giulini Chemie GmbH & Co, OHG |
| 3.0 | g | dispersing aid Mowiplus XW 330, Clariant |
| 3.0 | g | defoamer Agitan ® 310; Münzing-Chemie GmbH, Heilbronn |
| 3.0 | g | sodium hydroxide solution (10%) |
| 2.0 | g | preservative Mergal ® K 9 N; Troy Chemie GmbH, Seelze |

The following is added with stirring:

| | | |
|---|---|---|
| 175.0 | g | titanium dioxide pigment Kronos ® 2065; Kronos |
| | | Titan GmbH, Leverkusen |

The constituents are mixed for 20 minutes in a high-speed disperser. Subsequently the following constituents are added with stirring:

| | | |
|---|---|---|
| 724.7 | g | polymer dispersion A (49.0% by weight) |
| 37.0 | g | 1,2-propanediol |
| 10.0 | g | butyl diglycol acetate |

The pigment volume concentration (PVC) of the solventborne gloss paint is about 11.9%; the gloss paints of examples B1 to B5 were prepared using the dispersions A1 to A5 indicated in the following table:

Example

| | B1^{a)} | B2^{a)} | B3^{a)} | B4^{a)} | B5^{b)} |
|---|---|---|---|---|---|
| Dispersion | A1 | A2 | A3 | A4 | A5 |

^{a)}comparative example;
^{b)}inventive example

The thixotroping properties of the gloss paints B1 to B5 are summarized in table 2 (see below: section 111.1).

II.2 Preparation of Solvent-Free and Plasticizer-Free Interior Paints

Solvent-free and plasticizer-free interior paints are formulated from aqueous polymer dispersions A6 to A17. This is done by initially introducing the following constituents into a vessel:

| | | |
|---|---|---|
| 315.0 | g | water |
| 6.0 | g | hydroxyethylcellulose rheological assistant having a viscosity |
| | | of 300 mPas (determined as a 1.9% strength solution in water |
| | | at 25° C.); Tylose ® H 300 YG4; Clariant |
| 10.0 | g | 10% strength by weight solution of a sodium polyphosphate in |
| | | water, Calgon ®; BK Giulini Chemie GmbH & Co, OHG |
| 5.0 | g | dispersing aid Mowiplus XW 330, Clariant |
| 3.0 | g | defoamer Agitan ® 310; Münzing-Chemie GmbH, Heilbronn |
| 3.0 | g | sodium hydroxide solution (10%) |
| 2.0 | g | preservative Mergal ® K 9 N; Troy Chemie GmbH, Seelze |

The following is added with stirring:

| | | |
|---|---|---|
| 250.0 | g | titanium dioxide pigment Kronos ® 2065; Kronos |
| | | Titan GmbH, Leverkusen |
| 156.0 | g | calcium carbonate, calcite 5 μm - calcite mean particle size |
| | | 5 μm; Omyacarb 5 GU; Omya GmbH, Cologne |

The constituents are mixed for 20 minutes in a high-speed disperser. Subsequently the following constituents are added with stirring:

| | | |
|---|---|---|
| 238.7 | g | polymer dispersion A (53.0% by weight) |

The pigment volume concentration (PVC) of the solvent-free and plasticizer-free interior paints is about 50.3%; the interior paints of examples B6 to B17 were prepared using the dispersions A6 to A17 indicated in the following table:

| | Example | | | | | | | | | | | |
|---|---|---|---|---|---|---|---|---|---|---|---|---|
| | B6^{a)} | B7^{a)} | B8^{b)} | B9^{a)} | B10^{a)} | B11^{b)} | B12^{a)} | B13^{a)} | B14^{b)} | B15^{a)} | B16^{a)} | B17^{b)} |
| Dispersion | A6 | A7 | A14 | A8 | A9 | A15 | A10 | A11 | A16 | A12 | A13 | A17 |

^{a)}comparative example;
^{b)}inventive example

The thixotroping properties of these interior paints are summarized in table 3 (see below: section III.).

III. Preparation of Thixotropic Coating Compositions:

III.1 Thixotroping of Emulsion Paints

The emulsion paints described in examples B1-B17 were thixotroped by adding, with slow stirring (1000 rpm), an appropriate amount of heavy metal chelate Tilcom AT 23 (triethanolamine titanate from Titanium Intermediates Ltd., London) diluted with water in a 1:1 ratio.

24 hours after the addition of the heavy metal chelate the gel strength is measured in an ICI gel strength tester (ICI Rotothinner for paints, Sheen Instruments Ltd., Sheendale Road, Richmond, Surrey, England, serial number 771331). The thixotroping was performed in each case at the percentage by weight indicated in the tables below, based on the total weight of the emulsion paint. In all cases it was possible to eliminate the gel structure by means of severe sheering stress, and on subsequent standing the gel structure was largely reestablished in the previous gel strength.

TABLE 2
Thixotroping behavior of the gloss paints from examples B1 to B5

| | | Stabilization of the dispersion A present in the gloss | | | | | | |
|---|---|---|---|---|---|---|---|---|
| | | paint B | | | | | | |
| | | | | Nonionic | | | | |
| | | Protective | Amount | emulsifier | Ionic emulsifier | Gel strength Tilcom AT 23 addition^{e)} | | |
| Example | Gloss paint | colloid^{c)} | [pphm^{d)}] | [pphm^{d)}] | [pphm^{d)}] | 0.3% by weight | 0.5% by weight | 0.7% by weight |
| C1a^{a)} | B1^{a)} | H20 | 1.0 | 3 | 0 | 0 | | |
| C1b^{a)} | | | | | | | 6 | |
| C1c^{a)} | | | | | | | | 15 |
| C2a^{a)} | B2^{a)} | H20 | 2.0 | 3 | 0 | 13 | | |
| C2b^{a)} | | | | | | | 34 | |
| C2c^{a)} | | | | | | | | 63 |
| C3a^{a)} | B3^{a)} | H200 | 1.0 | 3 | 0 | 4 | | |
| C3b^{a)} | | | | | | | 11 | |
| C3c^{a)} | | | | | | | | 31 |
| C4a^{a)} | B4^{a)} | H200 | 2.0 | 3 | 0 | 12 | | |
| C4b^{a)} | | | | | | | 45 | |
| C4c^{a)} | | | | | | | | 90 |
| C5a^{b)} | B5^{b)} | HL40 AM | 1.0 | 3 | 0 | 55 | | |
| C5b^{b)} | | | | | | | 139 | |
| C5c^{b)} | | | | | | | | 214 |

^{a)}Comparative example;
^{b)}inventive example;
^{c)}hydroxyethylcelluloses: H20 = Tylose H20, Clariant GmbH, H200 = Tylose H200, Clariant GmbH; HL 40 AM = Tylose HL 40 AM, allyl-modified hydroxyethylcellulose from Clariant GmbH;
^{d)}pphm = amount used in parts by weight per 100 parts by weight of monomer;
^{e)}amount added based on total mass of emulsion paint B.

TABLE 3
Thixotroping behavior of the interior paints from examples B6 to B11 (single-stage dispersions)

| | | Stabilization of the dispersion A (single-stage | | | | | | |
|---|---|---|---|---|---|---|---|---|
| | | dispersions) present in the gloss paint B | | | | | | |
| | | | | Nonionic | | | | |
| | | Protective | Amount | emulsifier | Ionic emulsifier | Gel strength after Tilcom AT 23 addition^{e)} | | |
| Example | Gloss paint | colloid^{c)} | [pphm^{d)}] | [pphm^{d)}] | [pphm^{d)}] | 0.5% by weight | 0.75% by weight | 1.0% by weight |
| C6a^{a)} | B6 | 250 GR | 1.0 | 3 | 0.2 | 16 | | |
| C6b^{a)} | | | | | | | 33 | |
| C6c^{a)} | | | | | | | | 78 |
| C7a^{a)} | B7 | 250 GR | 2.0 | | | 22 | | |
| C7b^{a)} | | | | | | | 53 | |
| C7c^{a)} | | | | | | | | 102 |
| C8a^{b)} | B8 | HL40 AM | 1.0 | | | 61 | | |
| C8b^{b)} | | | | | | | 108 | |
| C8c^{b)} | | | | | | | | 202 |
| C9a^{a)} | B9 | 250 GR | 1.0 | 0 | 2.1 | 12 | | |
| C9b^{a)} | | | | | | | 32 | |
| C9c^{a)} | | | | | | | | 63 |
| C10a^{a)} | B10 | 250 GR | 2.0 | | | 27 | | |
| C10b^{a)} | | | | | | | 62 | |
| C10c^{a)} | | | | | | | | 113 |
| C11a^{a)} | B11 | HL40 AM | 1.0 | | | 98 | | |
| C11b^{a)} | | | | | | | 146 | |
| C11c^{a)} | | | | | | | | 225 |

^{a)}Comparative example;
^{b)}inventive example;
^{c)}hydroxyethylcelluloses: 250 GR = Natrosol 250 GR, Hercules, HL 40 AM = Tylose HL 40 AM, allyl-modified hydroxyethylcellulose from Clariant GmbH;
^{d)}pphm = amount used in parts by weight per 100 parts by weight of monomer;
^{e)}amount added based on total mass of emulsion paint B.

TABLE 4
Thixotroping behavior of the interior paints from examples B12 to B17 (two-stage dispersions)

| | | Stabilization of the dispersion A (single-stage dispersions) | | | | | | |
|---|---|---|---|---|---|---|---|---|
| | | present in the gloss paint B | | | | | | |
| | | Protective | | Nonionic emulsifier | Ionic emulsifier | Gel strength after Tilcom AT 23 addition^{e)} | | |
| Example | Gloss paint | colloid^{c)} | Amount [pphm^{d)}] | [pphm^{d)}] | [pphm^{d)}] | 0.5% by weight | 0.75% by weight | 1.0% by weight |
| C12a^{a)} | B12 | 250 GR | 1.0 | 3 | 0.2 | 17 | | |
| C12b^{a)} | | | | | | | 39 | |
| C12c^{a)} | | | | | | | | 82 |
| C13a^{a)} | B13 | 250 GR | 2.0 | | | 32 | | |
| C13b^{a)} | | | | | | | 63 | |
| C13c^{a)} | | | | | | | | 125 |
| C14a^{b)} | B14 | AL H40 AM | 1.0 | | | 72 | | |
| C14b^{b)} | | | | | | | 132 | |
| C14c^{b)} | | | | | | | | 217 |
| C15a^{a)} | B15 | 250 GR | 1.0 | 0 | 2.1 | 12 | | |
| C15b^{a)} | | | | | | | 37 | |
| C15c^{a)} | | | | | | | | 73 |
| C16a^{a)} | B16 | 250 GR | 2.0 | | | 29 | | |
| C16b^{a)} | | | | | | | 59 | |
| C16c^{a)} | | | | | | | | 107 |
| C17a^{b)} | B17 | HL40 AM | 1.0 | | | 104 | | |
| C17b^{b)} | | | | | | | 154 | |
| C17c^{b)} | | | | | | | | 232 |

^{a)}Comparative example;
^{b)}inventive example;
^{c)}hydroxyethylcelluloses: H20 = Tylose H20, Clariant GmbH, H200 = Tylose H200, Clariant GmbH; HL 40 AM = Tylose HL 40 AM, allyl-modified hydroxyethylcellulose from Clariant GmbH;
^{d)}pphm = amount used in parts by weight per 100 parts by weight of monomer;
^{e)}amount added based on total mass of emulsion paint B.

The gel strengths listed in tables 2-4 depend heavily on the composition of the dispersions used for preparing the emulsion paints B1-B17, and so are comparable with one another only where the dispersions are of the same kind.

Comparison of examples C1-C5 illustrates that the inventive aqueous coating composition B5 is distinguished over the comparison paints B1-B4 by drastically improved thixotropic properties. Thus the inventive gloss paint B5, with either the same or even with a lower added amount of titanium chelate, exhibits a significantly higher thixotropability (gel strength) (compare examples C5b and C5c versus C1c, C2c, C3c, and C4c). This applies in particular to gloss paints B2 and. B4 as well, which were formulated with dispersions whose preparation took place in the presence of twice the amount of hydroxyl-containing protective colloid (C5 versus C2 and C4). From comparison of examples C1, C3, and C5 it can be inferred that the high gel strength in the case of the inventive thixotropic gloss paints C5 is not attributable to different molecular weights of the hydroxyl-containing protective colloids used for preparing the dispersion (C5c versus C1c and C3c, and C5b versus C1b and C3b, and C5a versus C1a and C3a) but instead is based on the use of a dispersion which comprises an ethylenically unsaturated hydroxyl-containing protective colloid.

The interior paint examples C6-C17 underline the fact that the effect according to the invention not only occurs independently of the emulsifier system in the dispersions used to prepare the interior paints (compare in each case C6-C8, C9-C11, C12-C14, and C15-C17) but is also independent of whether the dispersions were prepared by a single-stage or multistage polymerization process.

1-20. (canceled)

21. An aqueous coating material with binder, comprising
at least one aqueous polymer dispersion based on a homopolymer, copolymer, or combination thereof derived from (α,β-unsaturated compounds (m), said aqueous polymer dispersion further comprising at least one hydroxyl-containing protective colloid having ethylenically unsaturated radicals.

22. A coating material as claimed in claim 21, wherein the homopolymer, copolymer, or combinations thereof are derived from principal monomers (MP) which are selected from the group consisting of vinyl esters of carboxylic acids having 1 to 18 carbon atoms (MP1), monoesters of ethylenically unsaturated C₃-C₈ monocarboxylic and dicarboxylic acids with C₁-C₁₈ alkanols (MP2), aromatic or aliphatic (α,β-unsaturated, optionally halogen-substituted hydrocarbons (MP3), and functional monomers (MF) selected from the group consisting of ionic monomers (MF1), nonionic monomers (MF2), ethylenically unsaturated monomers (MF3), or a combination thereof.

23. A coating material as claimed in claim 21, wherein the homopolymer, copolymer, or combination thereof is derived from monomer mixtures selected from the group consisting of vinyl acetate/vinyl chloride/ethene, vinyl acetate/vinyl laurate/ethene, vinyl acetate/vinyl laurate/ethene/vinyl chloride, vinyl acetate/Versatic acid vinyl ester/ethene/vinyl chloride, Versatic acid vinyl ester/ethene/vinyl chloride, vinyl acetate/Versatic acid vinyl ester/ethene, vinyl acetate/ethene, vinyl acetate/butyl acrylate, vinyl acetate/dibutyl maleate, vinyl acetate/dibutyl fumarate, vinyl acetate/2-ethylhexyl acrylate, vinyl acetate/ethene/butyl acrylate, vinyl acetate/ethene/dibutyl maleate, vinyl acetate/ethene/dibutyl fumarate, vinyl acetate/ethene/2-ethylhexyl acrylate, methyl methacrylate/butyl acrylate, methyl methacrylate/2-ethylhexyl acrylate, styrene/butyl acrylate, styrene/2-ethylhexyl acrylate, methyl methacrylate/isobutyl acrylate, or methyl methacrylate/isopropyl acrylate.

24. A coating material as claimed in claim 22, wherein the homopolymer, copolymer, or combination thereof is derived from monomer mixtures selected from the group consisting of vinyl acetate/vinyl chloride/ethene, vinyl acetate/vinyl laurate/ethene, vinyl acetate/vinyl laurate/ethene/vinyl chloride, vinyl acetate/Versatic acid vinyl ester/ethene/vinyl chloride, Versatic acid vinyl ester/ethene/vinyl chloride, vinyl acetate/Versatic acid vinyl ester/ethene, vinyl acetate/ethene, vinyl acetate/butyl acrylate, vinyl acetate/dibutyl maleate, vinyl acetate/dibutyl fumarate, vinyl acetate/2-ethylhexyl acrylate, vinyl acetate/ethene/butyl acrylate, vinyl acetate/ethene/dibutyl maleate, vinyl acetate/ethene/dibutyl fumarate, vinyl acetate/ethene/2-ethylhexyl acrylate, methyl methacrylate/butyl acrylate, methyl methacrylate/2-ethylhexyl acrylate, styrene/butyl acrylate, styrene/2-ethylhexyl acrylate, methyl methacrylate/isobutyl acrylate, or methyl methacrylate/isopropyl acrylate.

25. A coating material as claimed in claim 21, wherein the amount of hydroxyl-containing protective colloid having ethylenically unsaturated radicals is 0.05-25% by weight, based on the total mass of the monomers used to prepare the dispersion.

26. A coating material as claimed in claim 21, wherein the amount of hydroxyl-containing protective colloid having ethylenically unsaturated radicals is 0.4-5% by weight, based on the total mass of the monomers used to prepare the dispersion.

27. A coating material as claimed in claim 21 wherein said hydroxyl-containing protective colloid comprises cellulose ethers.

28. A coating material as claimed in claim 27 wherein said cellulose ethers have an MS of unsaturated radicals (R_{unsturated}) in the range of from 0.001 to 1.0.

29. A coating material as claimed in claim 27 wherein said cellulose ethers have an MS of unsaturated radicals (R_{unsturated}) in range of from 0.02 to 0.04.

30. A coating material as claimed in claim 21, wherein said hydroxyl-containing protective colloids are cellulose ethers synthesized from cellulose selected from the group consisting of methylcellulose, hydroxyethylcellulose, hydroxypropylcellulose, dihydroxypropylcellulose, carboxymethylcellulose, sulfoethylcellulose, methylhydroxyethylcellulose, methylhydroxypropylcellulose, methyldihydroxypropylcellulose, methylcarboxymethylcellulose, methylsulfoethylcellulose, ethylhydroxyethylcellulose, ethylhydroxypropylcellulose, ethyldihydroxypropylcellulose, ethylcarboxymethylcellulose, ethylsulfoethylcellulose, ethylhydroxyethylcellulose, dihydroxypropylcellulose, sulfoethylcarboxymethylcellulose, dihydroxypropylsulfoethylcellulose, hydroxyethylsulfoethylcellulose, dihydroxypropylhydroxyethylcellulose, dihydroxypropylcarboxymethylcellulose hydroxyethylcarboxymethylcellulose, and the esters and salts thereof.

31. A coating material as claimed in claim 27, wherein said cellulose ethers are synthesized from cellulose selected from the group consisting of methylcellulose, hydroxyethylcellulose, hydroxypropylcellulose, dihydroxypropylcellulose, carboxymethylcellulose, sulfoethylcellulose, methylhydroxyethylcellulose, methylhydroxypropylcellulose, methyldihydroxypropylcellulose, methylcarboxymethylcellulose, methylsulfoethylcellulose, ethylhydroxyethylcellulose, ethylhydroxypropylcellulose, ethyldihydroxypropylcellulose, ethylcarboxymethylcellulose, ethylsulfoethylcellulose, ethylhydroxyethylcellulose, dihydroxypropylcellulose, sulfoethylcarboxymethylcellulose, dihydroxypropylsulfoethylcellulose, hydroxyethylsulfoethylcellulose, dihydroxypropylhydroxyethylcellulose, dihydroxypropylcarboxymethylcellulose hydroxyethylcarboxymethylcellulose, and the esters and salts thereof.

32. A coating material as claimed in claim 21 wherein the hydroxyl-containing protective colloids comprise unsaturated radicals, R_{unsaturated}, containing double bond systems, where R_{unsaturated} is an alkenyl radical having more than 2 carbon atoms, C(O)CR¹═CHR² or C(O)CR³═CR⁴C(O)OR⁵, wherein R¹, R², R³, and R⁴ is H or Me and R⁵═H, C₁-C₈ alkyl, sodium, potassium, or ammonium.

33. A coating material as claimed in claim 30 wherein the hydroxyl-containing protective colloids comprise unsaturated radicals, R_{unsaturated}, containing double bond systems, where R_{unsaturated} is an alkenyl radical having more than 2 carbon atoms, C(O)CR¹═CHR² or C(O)CR³═CR⁴C(O)OR⁵, wherein R¹, R², R³, and R⁴ is H or Me and R⁵═H, C₁-C₈ alkyl, sodium, potassium, or ammonium.

34. A coating material as claimed in claim 21, wherein said hydroxyl-containing protective colloids are propenyl-substituted and butenyl-substituted cellulose ethers of hydroxyethylcellulose, hydroxypropylcellulose, dihydroxyethylcellulose, and dihydroxyethyl-hydroxyethylcellulose having an MS_{propenyl and/or butenyl} of from 0.001 to 1.0.

35. A coating material as claimed in claim 32, wherein said hydroxyl-containing protective colloids are propenyl-substituted and butenyl-substituted cellulose ethers of hydroxyethylcellulose, hydroxypropylcellulose, dihydroxyethylcellulose, and dihydroxyethyl-hydroxyethylcellulose having an MS_{propenyl and/or butenyl} of from 0.02 to 0.04.

36. A coating material as claimed in claim 21 wherein said hydroxyl-containing protective colloids are polyvinyl alcohols having at least one hydroxyl group substituted by ethylenically unsaturated radicals.

37. A coating material as claimed in claim 25 wherein said hydroxyl-containing protective colloids are polyvinyl alcohols having at least one hydroxyl group substituted by ethylenically unsaturated radicals.

38. A coating material as claimed in claim 21 further comprising, in addition to the hydroxyl-containing protective colloids, a second protective colloid selected from the group consisting of natural substances, modified natural substances, and synthetic substances.

39. A coating material as claimed in claim 36 further comprising, in addition to the hydroxyl-containing protective colloids, a second protective colloid selected from the group consisting of natural substances, modified natural substances, and synthetic substances.

40. A coating material as claimed in claim 21 further comprising at least one pigment.

41. A coating material as claimed in claim 38 further comprising at least one pigment.

42. A coating material as claimed in claim 40, comprising water, binders, fillers, pigments, and auxiliaries.

43. A coating material as claimed in claim 21 further comprising at least one thixotroping agent.

44. A coating material as claimed in claim 42 further comprising at least one thixotroping agent.

45. A coating material as claimed in claim 43 wherein said thixotroping agent has at least one metal chelate.

46. A coating material as claimed in claim 45, wherein said metal chelate contains titanium, zirconium, or a combination thereof.

47. A coating material as claimed in claim 36, wherein said metal chelates are the reaction products of isopropyl, n-butyl, low molecular weight ortho-esters of titanic acid, or a combination thereof with one or more compounds selected from the group consisting of glycols containing at least two free hydroxyl groups, glycol ethers containing at least one free hydroxyl group, mono, di, or tri alkanolamines, alpha-hydroxy carboxylic acids, which can optionally contain one or more hydroxyl groups per molecule, with the proviso that there is at least one hydroxyl group positioned alpha to the carboxyl group, and beta-keto-carbonyl compounds.

48. A coating material as claimed in claim 45, wherein the metal chelates are present in amounts in the range from 0.05 to 5% by weight, based on the total amount of the coating material.

49. A coating material as claimed in claim 48 wherein the metal chelates are present in amounts in the range from 0.1 to 2% by weight based on the total amount of the coating material.

50. A process for preparing a coating material as claimed in claim 21 wherein at least one α,β-unsaturated compound (M) is polymerized in an emulsion by a semicontinuous process, wherein at least 70% by weight of the monomers to be polymerized are supplied continuously by a stage or a gradient procedure to the polymerization batch.

51. The process of claim 50 wherein at least 90% of the monomers to be polymerized are supplied continuously by a stage or a gradient procedure to the polymerization batch.

52. The process as claimed in claim 50, wherein the metering of the individual monomers takes place by means of separate feeds or wherein the metering of the monomers is carried out such that the mixture of the metered monomer compositions is varied such that the resulting polymer has different polymer phases.

53. A process for preparing a coating material as claimed in claim 21 wherein at least one α,β-unsaturated compound (M) is polymerized batchwise in an emulsion.
